(19) United States
(12) Patent Application Publication
(10) Pub. No.: US 2025/0149676 A1
(43) Pub. Date: May 8, 2025

(54) COOLING OF BATTERY PACK OF VEHICLE

(71) Applicant: GM Global Technology Operations LLC, Detroit, MI (US)

(72) Inventors: Andrew Geoffrey Balding, Wixom, MI (US); Charles W. Toohy, Waterford, MI (US); William F. Spruit, Clarkston, MI (US)

(21) Appl. No.: 18/500,396

(22) Filed: Nov. 2, 2023

(51) Int. Cl. H01M 10/6557; H01M 10/613; H01M 10/647

(52) U.S. Cl. CPC H01M 10/6557; H01M 10/613; H01M 10/647; H01M 2220/20

(57) ABSTRACT

A battery assembly of a vehicle includes a first cell layer including a first plurality of battery cells, a second cell layer including a second plurality of battery cells, and a cold plate positioned between the first cell layer and the second cell layer. The cold plate includes a plurality of coolant pathways configured to flow a flow of coolant therethrough. The first plurality of battery cells contact a first side of the cold plate and the second plurality of battery cells contact a second side of the cold plate opposite the first side to cool the first plurality of battery cells and the second plurality of battery cells via the flow of coolant through the cold plate.

### INTRODUCTION

The subject disclosure relates to vehicles, and in particular to cooling of battery packs of vehicles.

High capacity battery packs are utilized in many consumer and industrial sectors categorically including transportation and power grid applications. High capacity battery packs are known to include a plurality of battery pack modules allowing for flexibility in configurations and adaptation to application requirements.

Such battery packs generate heat and internal pressure when placed under load. Heat may have a detrimental effect on battery efficiency and/or battery life, and a buildup of internal pressure during a thermal event in the battery may result in shortened life of the battery pack. Accordingly, removing the heat and lowering the internal pressure provides a benefit to battery operation.

### SUMMARY

In one exemplary embodiment, a battery assembly of a vehicle includes a first cell layer including a first plurality of battery cells, a second cell layer including a second plurality of battery cells, and a cold plate positioned between the first cell layer and the second cell layer. The cold plate includes a plurality of coolant pathways configured to flow a flow of coolant therethrough. The first plurality of battery cells contact a first side of the cold plate and the second plurality of battery cells contact a second side of the cold plate opposite the first side to cool the first plurality of battery cells and the second plurality of battery cells via the flow of coolant through the cold plate.

In addition to one or more of the features described herein, the battery cells each have a first cell end and a second cell end opposite the first cell end, and the second cell end of each battery cell of the first cell layer and the second cell layer contacts the cold plate.

In addition to one or more of the features described herein, each battery cell includes an electrode stack located in a pouch, the pouch having a closure at the first cell end.

In addition to one or more of the features described herein, the second plurality of battery cells are inverted relative to the first plurality of battery cells.

In addition to one or more of the features described herein, a housing at least partially encloses the first cell layer, the second cell layer and the cold plate.

In addition to one or more of the features described herein, at least one of the first plurality of battery cells and the second plurality of battery cells are secured to the cold plate via a plurality of fasteners.

In addition to one or more of the features described herein, a battery disconnect unit is operably connected to one of the plurality of battery cells and cooled via the flow of coolant diverted from the cold plate via one of a fluidly parallel or series connection.

In another exemplary embodiment, a vehicle includes a vehicle body and a propulsion system to drive a movement of the vehicle. The propulsion system includes a battery assembly to power the propulsion system. The battery assembly includes a first cell layer including a first plurality of battery cells, a second cell layer including a second plurality of battery cells, and a cold plate positioned between the first cell layer and the second cell layer. The cold plate includes a plurality of coolant pathways configured to flow a flow of coolant therethrough. The first plurality of battery cells contact a first side of the cold plate and the second plurality of battery cells contact a second side of the cold plate opposite the first side to cool the first plurality of battery cells and the second plurality of battery cells via the flow of coolant through the cold plate.

In addition to one or more of the features described herein, the battery cells each have a first cell end and a second cell end opposite the first cell end, and the second cell end of each battery cell of the first cell layer and the second cell layer contacts the cold plate.

In addition to one or more of the features described herein, each battery cell includes an electrode stack located in a pouch, the pouch having a closure at the first cell end.

In addition to one or more of the features described herein, the second plurality of battery cells are inverted relative to the first plurality of battery cells.

In addition to one or more of the features described herein, a housing at least partially encloses the first cell layer, the second cell layer and the cold plate.

In addition to one or more of the features described herein, at least one of the first plurality of battery cells and the second plurality of battery cells are secured to the cold plate via a plurality of fasteners.

In addition to one or more of the features described herein, a battery disconnect unit is operably connected to one of the plurality of battery cells and cooled via the flow of coolant.

In yet another exemplary embodiment, a method of assembling a battery assembly includes assembling a first plurality of battery cells to a first side of a cold plate. The cold plate includes a plurality of coolant pathways configured to flow a flow of coolant therethrough. A second plurality of battery cells is assembled to a second side of the cold plate opposite the first side. The first plurality of battery cells contact a first side of the cold plate and the second plurality of battery cells contact the second side of the cold plate to cool the first plurality of battery cells and the second plurality of battery cells via the flow of coolant through the cold plate.

In addition to one or more of the features described herein, the battery cells each have a first cell end and a second cell end opposite the first cell end, and the second cell end of each battery cell of the first plurality of battery cells and the second plurality of battery cells contacts the cold plate.

In addition to one or more of the features described herein, each battery cell includes an electrode stack positioned in a pouch, the pouch having a closure at the first cell end.

In addition to one or more of the features described herein, the second plurality of battery cells are inverted relative to the first plurality of battery cells.

In addition to one or more of the features described herein, the first plurality of battery cells, the second plurality of battery cells, and the cold plate are enclosed in a housing.

In addition to one or more of the features described herein, a battery disconnect unit is operably connected to one of the plurality of battery cells the cold plate to be cooled via the flow of coolant.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic illustration of an embodiment of a vehicle;

FIG. 2 is a partial cross-sectional view of an embodiment of a battery assembly;

FIG. 3 is another partial cross-sectional view of an embodiment of a battery assembly;

FIG. 4A. is a first illustration of a method of assembling a battery assembly;

FIG. 4B. is a second illustration of a method of assembling a battery assembly; and

FIG. 4C. is a third illustration of a method of assembling a battery assembly.

### DETAILED DESCRIPTION

The following description is merely exemplary in nature and is not intended to limit the present disclosure, its application or uses. It should be understood that throughout the drawings, corresponding reference numerals indicate like or corresponding parts and features.

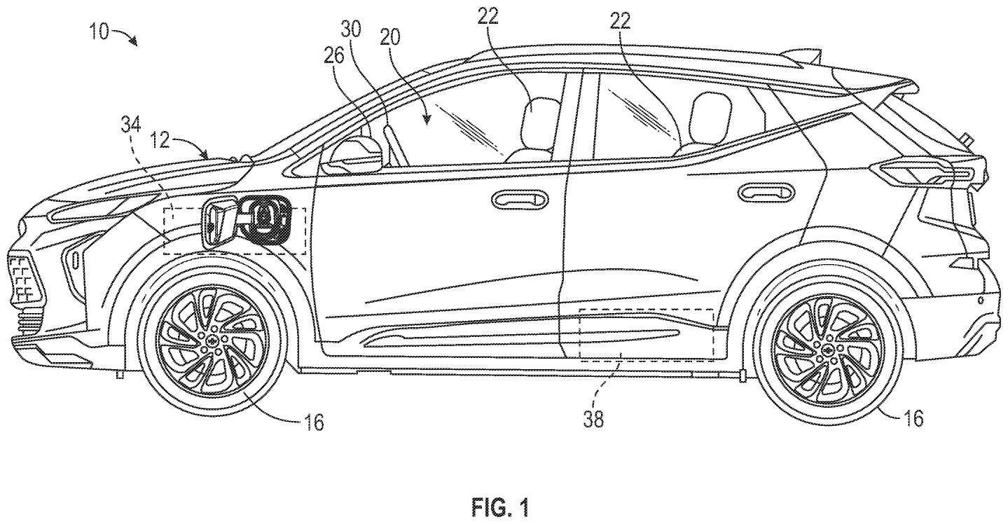

In accordance with an exemplary embodiment a vehicle, in accordance with a non-limiting example, is indicated generally at 10 in FIG. 1. Vehicle 10 includes a body 12 supported on a plurality of wheels 16. In a non-limiting example, two of the plurality of wheels 16 are steerable. Body 12 defines, in part, a passenger compartment 20 having seats 22 positioned behind a dashboard 26. A steering control 30 is arranged between seats 22 and dashboard 26. Steering control 30 is operated to control orientation of the steerable wheel(s). Vehicle 10 includes an electric motor 34 connected to a transmission that provides power to one or more of the plurality of wheels 16. A rechargeable energy storage system (RESS) or battery assembly 38 provides power to electric motor 34.

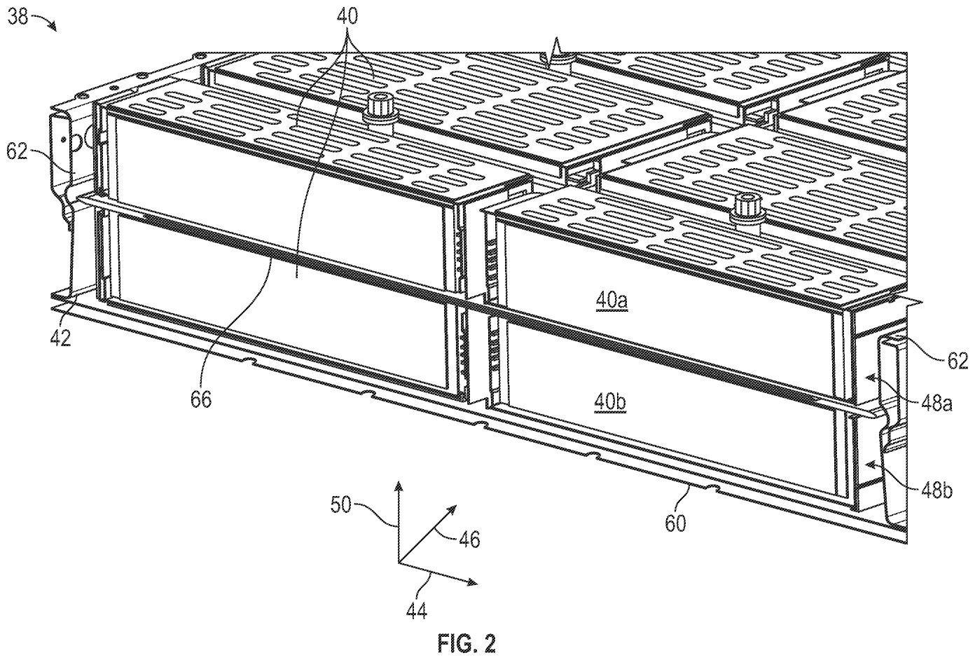

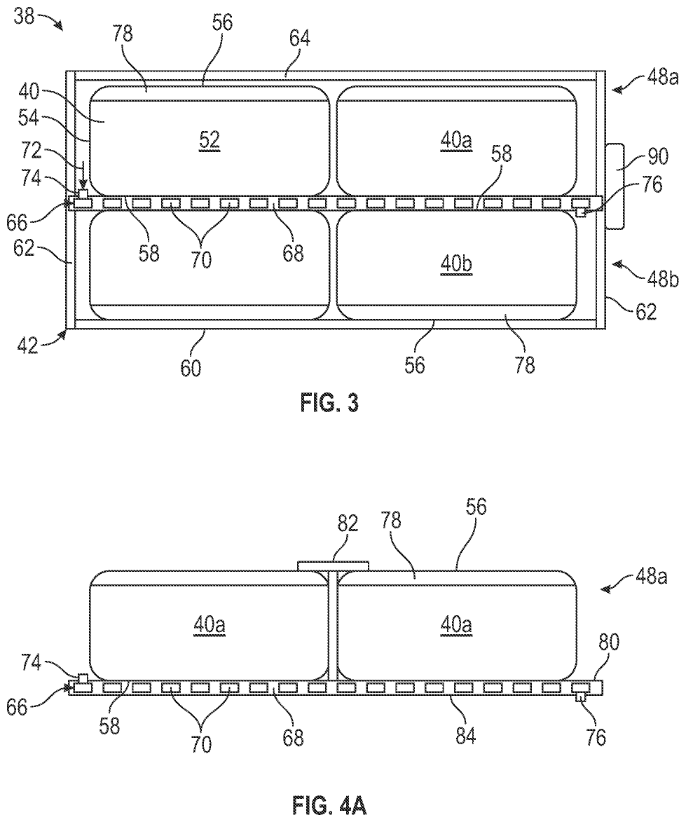

Referring now to FIG. 2, an embodiment of a battery assembly 38 is illustrated. The battery assembly 38 is in some embodiments a Lithium-ion battery, but one skilled in the art will readily appreciate that other suitable types of batteries may be utilized. The battery assembly 38 includes a plurality of battery cells 40 disposed in a battery enclosure 42, which at least partially encloses the plurality of battery cells 40. The battery cells 40 are positioned in the battery enclosure 42 arrayed along a tray length direction 46 and across a tray width direction 44, and are arranged in at least two cell layers 48a and 48b in a tray height direction 50. Referring now to FIG. 3, each battery cell 40 includes an electrode stack 52 in a cell housing 54 and includes a first cell end 56 and a second cell end 58. In some embodiments, the battery cells 40 are “pouch” battery cells in which the cell housing 54 is configured as a pouch, having a closure 78 such as a zip closure or the like at the first cell end 56. In some embodiments, the configuration of the battery cells 40 in a first cell layer 48a is identical to the configuration of the battery cells 40 in a second cell layer 48b.

The battery enclosure 42 includes a bottom panel 60, such as a floor panel, opposing side panels 62 and a cover 64, thus defining the battery enclosure 42 to at least partially surround the battery cells 40. Further, the battery enclosure 42 includes a cold plate 66 positioned between the first cell layer 48a and the second cell layer 48b. The cold plate 66 includes a plate body 68 and a plurality of coolant pathways 70 formed in the plate body 68. A flow of coolant 72 is circulated through the plurality of coolant pathways 70, entering the cold plate 66 at a coolant inlet 74 and exiting the cold plate 66 at a coolant outlet 76. In some embodiments, the battery assembly 38 includes a battery disconnect unit (BDU) 90 which monitors, activates, and deactivates the battery assembly 38. The BDU 90 is connected to the cold plate 66 and utilizes coolant 72 diverted from the cold plate 66 for cooling of the BDU 90. The coolant 72 is delivered to the BDU 90 by way of connection to the cold plate 66 in either a fluidly parallel or series arrangement. After flowing through the BDU 90 to cool the BDU 90, the coolant 72 is returned to the cold plate 66.

The cold plate 66 together with the first cell layer 48a and the second cell layer 48b are positioned to cool both of the first cell layer 48a and the second cell layer 48b via thermal energy exchange between the battery cells 40 of the first cell layer 48a and the second cell layer 48b and the flow of coolant 72 via the cold plate 66. In particular, to facilitate efficient thermal energy exchange and cooling of the battery cells 40, the battery cells 40b of the second cell layer 48b are inverted relative to the battery cells 40a of the first cell layer 48a. When installed into the battery enclosure 42, the battery cells 40a of the first cell layer 48a are both arranged so their respective second cell ends 58 abut the cold plate 66, so that the first cell ends 56 having the closure 78 are further from the cold plate 66 than the second cell ends 58. Positioning each of the second cell ends 58 to abut the cold plate 66 improves the efficiency of the thermal energy transfer between the battery cells 40 of each of the cell layers 48a, 48b and the cold plate 66.

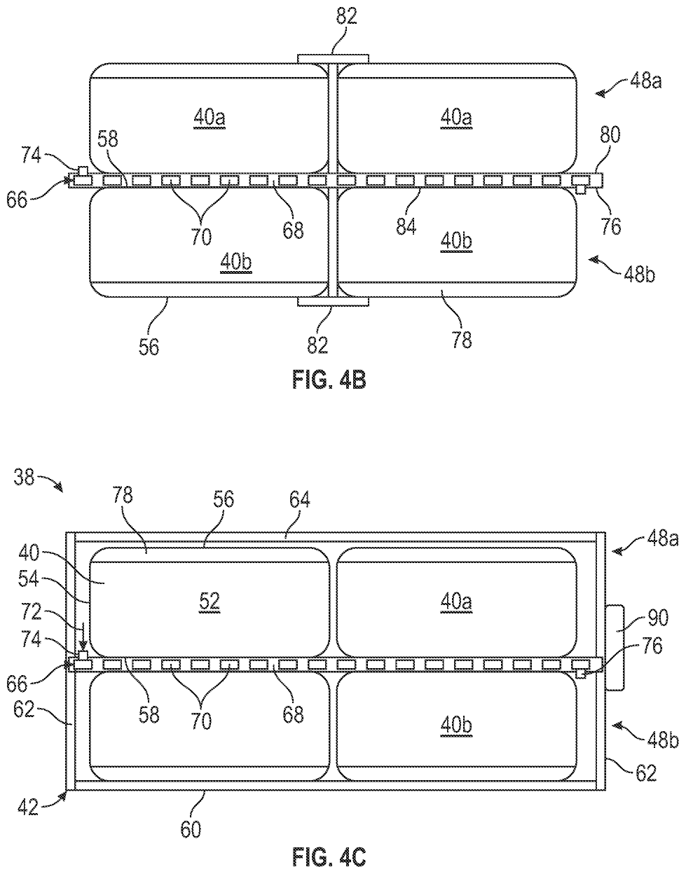

Referring now to FIGS. 4A-4C, a method of assembling a battery assembly 38 is illustrated. The battery cells 40a of the first cell layer 48a are installed to a first side 80 of the cold plate 66 via, for example, a plurality of fasteners 82 with the second cell ends 58 abutting the first side 80 so there is full contact between the second cell ends 58 and the first side 80. As shown in FIG. 4B, the battery cells 40b of the second cell layer 48b are installed to a second side 84 of the cold plate 66 opposite the first side 80 via, for example, a plurality of fasteners. The battery cells 40b are installed with the second ends 58 abutting the second side 84 so there is full contact between the second cell ends 58 and the second side 84. Referring now to FIG. 4C, the battery cell 40 and cold plate 66 subassembly may be installed into the battery enclosure 42, or alternatively the bottom panel 60, the opposing side panels 62 and the cover 64 are assembled around the battery cell 40 and cold plate 66 subassembly to enclose the battery assembly 38.

The configurations disclosed herein utilizes a common cold plate 66 to cool battery cells 40 in both cell layers 48a and 48b, reducing complexity of the cooling system of the battery assembly 38. This further allows for more compact packaging of the battery cells 40 in the battery assembly 38, while still providing the necessary cooling of the battery cells 40.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A battery assembly of a vehicle, comprising:
a first cell layer including a first plurality of battery cells;
a second cell layer including a second plurality of battery cells; and
a cold plate disposed between the first cell layer and the second cell layer, the cold plate including a plurality of coolant pathways configured to flow a flow of coolant therethrough;
wherein the first plurality of battery cells contact a first side of the cold plate and the second plurality of battery cells contact a second side of the cold plate opposite the first side to cool the first plurality of battery cells and the second plurality of battery cells via the flow of coolant through the cold plate.

2. The battery assembly of claim 1, wherein the battery cells each have a first cell end and a second cell end opposite the first cell end, and the second cell end of each battery cell of the first cell layer and the second cell layer contacts the cold plate.

3. The battery assembly of claim 2, wherein each battery cell includes an electrode stack disposed in a pouch, the pouch having a closure at the first cell end.

4. The battery assembly of claim 1, wherein the second plurality of battery cells are inverted relative to the first plurality of battery cells.

5. The battery assembly of claim 1, further comprising a housing at least partially enclosing the first cell layer, the second cell layer and the cold plate.

6. The battery assembly of claim 1, wherein at least one of the first plurality of battery cells and the second plurality of battery cells are secured to the cold plate via a plurality of fasteners.

7. The battery assembly of claim 1, further comprising a battery disconnect unit operably connected to one of the plurality of battery cells and cooled via the flow of coolant diverted from the cold plate via one of a fluidly parallel or series connection.

8. A vehicle comprising:
a vehicle body;
a propulsion system to drive a movement of the vehicle, the propulsion system including a battery assembly to power the propulsion system, the battery assembly including:
a first cell layer including a first plurality of battery cells;
a second cell layer including a second plurality of battery cells; and
a cold plate disposed between the first cell layer and the second cell layer, the cold plate including a plurality of coolant pathways configured to flow a flow of coolant therethrough;
wherein the first plurality of battery cells contact a first side of the cold plate and the second plurality of battery cells contact a second side of the cold plate opposite the first side to cool the first plurality of battery cells and the second plurality of battery cells via the flow of coolant through the cold plate.

9. The vehicle of claim 8, wherein the battery cells each have a first cell end and a second cell end opposite the first cell end, and the second cell end of each battery cell of the first cell layer and the second cell layer contacts the cold plate.

10. The vehicle of claim 9, wherein each battery cell includes an electrode stack disposed in a pouch, the pouch having a closure at the first cell end.

11. The vehicle of claim 8, wherein the second plurality of battery cells are inverted relative to the first plurality of battery cells.

12. The vehicle of claim 8, further comprising a housing at least partially enclosing the first cell layer, the second cell layer and the cold plate.

13. The vehicle of claim 8, wherein at least one of the first plurality of battery cells and the second plurality of battery cells are secured to the cold plate via a plurality of fasteners.

14. The vehicle of claim 8, further comprising a battery disconnect unit operably connected to one of the plurality of battery cells and cooled via the flow of coolant.

15. A method of assembling a battery assembly, comprising:
assembling a first plurality of battery cells to a first side of a cold plate, the cold plate including a plurality of coolant pathways configured to flow a flow of coolant therethrough; and
assembling a second plurality of battery cells to a second side of the cold plate opposite the first side;
wherein the first plurality of battery cells contact a first side of the cold plate and the second plurality of battery cells contact the second side of the cold plate to cool the first plurality of battery cells and the second plurality of battery cells via the flow of coolant through the cold plate.

16. The method of claim 15, wherein the battery cells each have a first cell end and a second cell end opposite the first cell end, and the second cell end of each battery cell of the first plurality of battery cells and the second plurality of battery cells contacts the cold plate.

17. The method of claim 16, wherein each battery cell includes an electrode stack disposed in a pouch, the pouch having a closure at the first cell end.

18. The method of claim 15, wherein the second plurality of battery cells are inverted relative to the first plurality of battery cells.

19. The method of claim 15, further comprising enclosing the first plurality of battery cells, the second plurality of battery cells, and the cold plate in a housing.

20. The method of claim 15, further comprising operably connecting a battery disconnect unit operably to one of the plurality of battery cells the cold plate to be cooled via the flow of coolant.
